(19) United States
(12) Patent Application Publication
(10) Pub. No.: US 2025/0190551 A1
(43) Pub. Date: Jun. 12, 2025

(54) SELF-LEARNING DATA MIGRATION WITH PRIORITIZATION

(71) Applicant: Dell Products L.P., Round Rock, TX (US)

(72) Inventors: Parminder Singh SETHI, Punjab (IN); Anay KISHORE, Bangalore (IN); Malathi RAMAKRISHNAN, Madurai (IN); Daniel L. HAMLIN, Round Rock, TX (US); Praveen KUMAR, Noida (IN)

(73) Assignee: Dell Products L.P., Round Rock, TX (US)

(21) Appl. No.: 18/537,561

(22) Filed: Dec. 12, 2023

(51) Int. Cl. G06F 21/55; G06F 16/11

(52) U.S. Cl. CPC G06F 21/554; G06F 16/119

(57) ABSTRACT

An information handling system may include at least one processor and a memory. The information handling system may be configured to implement a data edge client that is configured to migrate data from a source system to a target system by: performing validation prior to the migration; receiving data prioritization logic; transferring the data from the source system to the target system in accordance with the prioritization logic; monitoring for threats during the transferring; and in response to detecting a threat, performing a remedial action.

### TECHNICAL FIELD

The present disclosure relates in general to information handling systems, and more particularly to techniques for migrating data from one system to another.

### BACKGROUND

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

Hyper-converged infrastructure (HCI) is an IT framework that combines storage, computing, and networking into a single system in an effort to reduce data center complexity and increase scalability. Hyper-converged platforms may include a hypervisor for virtualized computing, software-defined storage, and virtualized networking, and they typically run on standard, off-the-shelf servers. One type of HCI solution is the Dell EMC VxRail™ system. Some examples of HCI systems may operate in various environments (e.g., an HCI management system such as the VMware® vSphere® ESXi™ environment, or any other HCI management system). Some examples of HCI systems may operate as software-defined storage (SDS) cluster systems (e.g., an SDS cluster system such as the VMware® vSAN™ system, or any other SDS cluster system).

In the HCI context (as well as other contexts), information handling systems may execute virtual machines (VMs) for various purposes. A VM may generally comprise any program of executable instructions, or aggregation of programs of executable instructions, configured to execute a guest operating system on a hypervisor or host operating system in order to act through or in connection with the hypervisor/host operating system to manage and/or control the allocation and usage of hardware resources such as memory, central processing unit time, disk space, and input and output devices, and provide an interface between such hardware resources and application programs hosted by the guest operating system.

There are sometimes situations when large amounts of data (e.g., several terabytes) may need to be migrated from one information handling system to another (e.g., from an edge deployment of one HCI system to another HCI system, or to a cloud system, or to a non-HCI system, etc.) via a network connection. Various issues may arise, however.

For example, the data may need to be validated prior to migration. If a warning occurs during such validation, it may block the entire migration until it is addressed (e.g., by an administrator logging in and acknowledging the warning). This may cause large delays, because the administrator may not even be aware of the problem preventing the migration. It would be advantageous not to stop the migration even if a warning occurs. In that event, certain data that is of less significance may proceed to be migrated even while the warning is pending, and the whole process of migration need not be blocked for certain false signals. Even if the warning is valid, there may be an option to revert the migration later or take some appropriate action to handle the warning without blocking or canceling the migration process.

Further, with the growing number of device and solution types, the need for data migrations is also growing. It is becoming difficult to impossible for one central server to facilitate and manage all of the data migrations worldwide for a large organization. Also, with several new types of attacks becoming prevalent, it is increasingly challenging to learn from these attacks and find all possible patterns of threats.

It should be noted that the discussion of a technique in the Background section of this disclosure does not constitute an admission of prior-art status. No such admissions are made herein, unless clearly and unambiguously identified as such.

### SUMMARY

In accordance with the teachings of the present disclosure, the disadvantages and problems associated with data migration may be reduced or eliminated.

In accordance with embodiments of the present disclosure, an information handling system may include at least one processor and a memory. The information handling system may be configured to implement a data edge client that is configured to migrate data from a source system to a target system by: performing validation prior to the migration; receiving data prioritization logic; transferring the data from the source system to the target system in accordance with the prioritization logic; monitoring for threats during the transferring; and in response to detecting a threat, performing a remedial action.

In accordance with these and other embodiments of the present disclosure, a method may include an information handling system implementing a data edge client that is configured to migrate data from a source system to a target system; the data edge client performing validation prior to the migration; the data edge client receiving data prioritization logic; the data edge client transferring the data from the source system to the target system in accordance with the prioritization logic; the data edge client monitoring for threats during the transferring; and in response to detecting a threat, the data edge client performing a remedial action.

In accordance with these and other embodiments of the present disclosure, an article of manufacture may include a non-transitory, computer-readable medium having computer-executable instructions thereon that are executable by a processor of an information handling system for: implementing a data edge client that is configured to migrate data from a source system to a target system; the data edge client performing validation prior to the migration; the data edge client receiving data prioritization logic; the data edge client transferring the data from the source system to the target system in accordance with the prioritization logic; the data edge client monitoring for threats during the transferring; and in response to detecting a threat, the data edge client performing a remedial action.

Technical advantages of the present disclosure may be readily apparent to one skilled in the art from the figures, description and claims included herein. The objects and advantages of the embodiments will be realized and achieved at least by the elements, features, and combinations particularly pointed out in the claims.

It is to be understood that both the foregoing general description and the following detailed description are examples and explanatory and are not restrictive of the claims set forth in this disclosure.

### BRIEF DESCRIPTION OF THE DRAWINGS

A more complete understanding of the present embodiments and advantages thereof may be acquired by referring to the following description taken in conjunction with the accompanying drawings, in which like reference numbers indicate like features, and wherein:

FIG. 1 illustrates a block diagram of an example information handling system, in accordance with embodiments of the present disclosure;

FIGS. 2-3 illustrate block diagrams of example architectures, in accordance with embodiments of the present disclosure; and

FIG. 4 illustrates an example method, in accordance with embodiments of the present disclosure.

### DETAILED DESCRIPTION

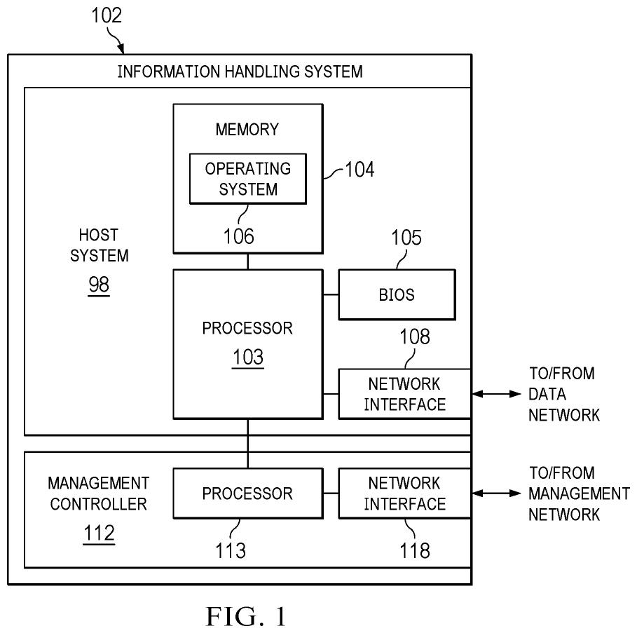

Preferred embodiments and their advantages are best understood by reference to FIGS. 1 through 4, wherein like numbers are used to indicate like and corresponding parts.

For the purposes of this disclosure, the term “information handling system” may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, entertainment, or other purposes. For example, an information handling system may be a personal computer, a personal digital assistant (PDA), a consumer electronic device, a network storage device, or any other suitable device and may vary in size, shape, performance, functionality, and price. The information handling system may include memory, one or more processing resources such as a central processing unit (“CPU”) or hardware or software control logic. Additional components of the information handling system may include one or more storage devices, one or more communications ports for communicating with external devices as well as various input/output (“I/O”) devices, such as a keyboard, a mouse, and a video display. The information handling system may also include one or more buses operable to transmit communication between the various hardware components.

For purposes of this disclosure, when two or more elements are referred to as “coupled” to one another, such term indicates that such two or more elements are in electronic communication or mechanical communication, as applicable, whether connected directly or indirectly, with or without intervening elements.

When two or more elements are referred to as “coupleable” to one another, such term indicates that they are capable of being coupled together.

For the purposes of this disclosure, the term “computer-readable medium” (e.g., transitory or non-transitory computer-readable medium) may include any instrumentality or aggregation of instrumentalities that may retain data and/or instructions for a period of time. Computer-readable media may include, without limitation, storage media such as a direct access storage device (e.g., a hard disk drive or floppy disk), a sequential access storage device (e.g., a tape disk drive), compact disk, CD-ROM, DVD, random access memory (RAM), read-only memory (ROM), electrically erasable programmable read-only memory (EEPROM), and/or flash memory; communications media such as wires, optical fibers, microwaves, radio waves, and other electromagnetic and/or optical carriers; and/or any combination of the foregoing.

For the purposes of this disclosure, the term “information handling resource” may broadly refer to any component system, device, or apparatus of an information handling system, including without limitation processors, service processors, basic input/output systems, buses, memories, I/O devices and/or interfaces, storage resources, network interfaces, motherboards, and/or any other components and/or elements of an information handling system.

For the purposes of this disclosure, the term “management controller” may broadly refer to an information handling system that provides management functionality (typically out-of-band management functionality) to one or more other information handling systems. In some embodiments, a management controller may be (or may be an integral part of) a service processor, a baseboard management controller (BMC), a chassis management controller (CMC), or a remote access controller (e.g., a Dell Remote Access Controller (DRAC) or Integrated Dell Remote Access Controller (iDRAC)).

FIG. 1 illustrates a block diagram of an example information handling system 102, in accordance with embodiments of the present disclosure. In some embodiments, information handling system 102 may comprise a server chassis configured to house a plurality of servers or “blades.” In other embodiments, information handling system 102 may comprise a personal computer (e.g., a desktop computer, laptop computer, mobile computer, and/or notebook computer). In yet other embodiments, information handling system 102 may comprise a storage enclosure configured to house a plurality of physical disk drives and/or other computer-readable media for storing data (which may generally be referred to as “physical storage resources”). As shown in FIG. 1, information handling system 102 may comprise a processor 103, a memory 104 communicatively coupled to processor 103, a BIOS 105 (e.g., a UEFI BIOS) communicatively coupled to processor 103, a network interface 108 communicatively coupled to processor 103, and a management controller 112 communicatively coupled to processor 103.

In operation, processor 103, memory 104, BIOS 105, and network interface 108 may comprise at least a portion of a host system 98 of information handling system 102. In addition to the elements explicitly shown and described, information handling system 102 may include one or more other information handling resources.

Processor 103 may include any system, device, or apparatus configured to interpret and/or execute program instructions and/or process data, and may include, without limitation, a microprocessor, microcontroller, digital signal processor (DSP), application specific integrated circuit (ASIC), or any other digital or analog circuitry configured to interpret and/or execute program instructions and/or process data. In some embodiments, processor 103 may interpret and/or execute program instructions and/or process data stored in memory 104 and/or another component of information handling system 102.

Memory 104 may be communicatively coupled to processor 103 and may include any system, device, or apparatus configured to retain program instructions and/or data for a period of time (e.g., computer-readable media). Memory 104 may include RAM, EEPROM, a PCMCIA card, flash memory, magnetic storage, opto-magnetic storage, or any suitable selection and/or array of volatile or non-volatile memory that retains data after power to information handling system 102 is turned off.

As shown in FIG. 1, memory 104 may have stored thereon an operating system 106. Operating system 106 may comprise any program of executable instructions (or aggregation of programs of executable instructions) configured to manage and/or control the allocation and usage of hardware resources such as memory, processor time, disk space, and input and output devices, and provide an interface between such hardware resources and application programs hosted by operating system 106. In addition, operating system 106 may include all or a portion of a network stack for network communication via a network interface (e.g., network interface 108 for communication over a data network). Although operating system 106 is shown in FIG. 1 as stored in memory 104, in some embodiments system 106 may be stored in storage media operating accessible to processor 103, and active portions of operating system 106 may be transferred from such storage media to memory 104 for execution by processor 103.

Network interface 108 may comprise one or more suitable systems, apparatuses, or devices operable to serve as an interface between information handling system 102 and one or more other information handling systems via an in-band network. Network interface 108 may enable information handling system 102 to communicate using any suitable transmission protocol and/or standard. In these and other embodiments, network interface 108 may comprise a network interface card, or “NIC.” In these and other embodiments, network interface 108 may be enabled as a local area network (LAN)-on-motherboard (LOM) card.

Management controller 112 may be configured to provide management functionality for the management of information handling system 102. Such management may be made by management controller 112 even if information handling system 102 and/or host system 98 are powered off or powered to a standby state. Management controller 112 may include a processor 113, memory, and a network interface 118 separate from and physically isolated from network interface 108.

As shown in FIG. 1, processor 113 of management controller 112 may be communicatively coupled to processor 103. Such coupling may be via a Universal Serial Bus (USB), System Management Bus (SMBus), and/or one or more other communications channels.

Network interface 118 may be coupled to a management network, which may be separate from and physically isolated from the data network as shown. Network interface 118 of management controller 112 may comprise any suitable system, apparatus, or device operable to serve as an interface between management controller 112 and one or more other information handling systems via an out-of-band management network. Network interface 118 may enable management controller 112 to communicate using any suitable transmission protocol and/or standard. In these and other embodiments, network interface 118 may comprise a network interface card, or “NIC.” Network interface 118 may be the same type of device as network interface 108, or in other embodiments it may be a device of a different type.

As discussed above, embodiments of this disclosure provide improvements in the migration of data among information handling systems 102 (e.g., edge nodes). It should be noted that while the scenario of an edge deployment is discussed in detail herein for the sake of concreteness, other embodiments are also specifically contemplated within the scope of this disclosure.

Three of the major challenges related to data migration include making the overall process of data migration secure and less blocking, handling and monitoring the large number of data migrations, and learning from attack patterns to make future transactions more secure.

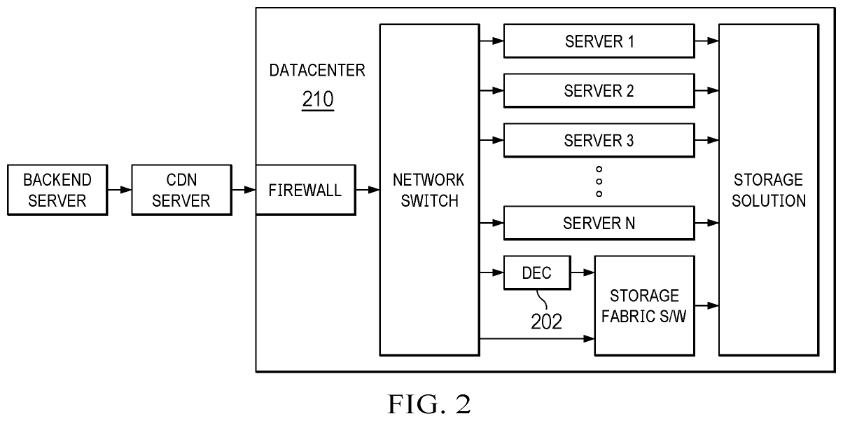

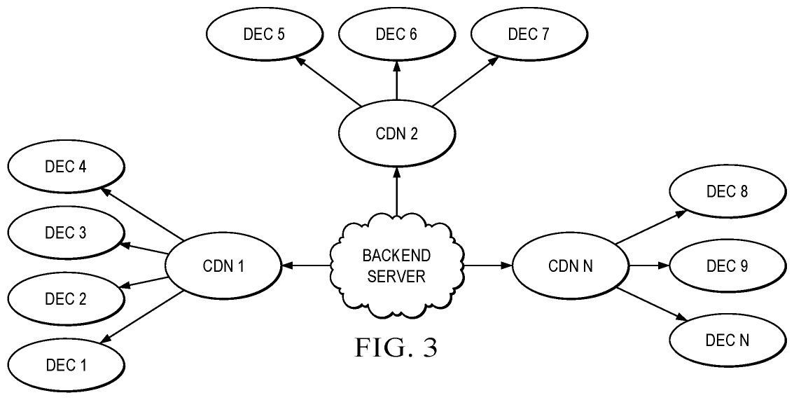

Accordingly, embodiments of this disclosure may make the overall process of data migration more secure by using a three-tier architecture in which the solution is distributed to address challenges at different levels. In one embodiment, the three tiers are as follows, and as illustrated in the architecture diagrams of FIG. 2 and FIG. 3.

Data Edge Client (DEC): DEC 202 may be physically deployed in a customer datacenter 210 to monitor the data migration process. It may be implemented based on the principles of edge computing (e.g., it may reside on one or more edge nodes of an HCI system).

Content Distribution Network (CDN) Server: CDN servers may be deployed throughout the world in different regions and countries based on their local business needs. CDN servers act as the first point of contact for the DECs. CDN servers may also be connected to the backend server to process the end-to-end flow of communications. Each CDN server may be responsible for multiple datacenters 210 and DECs 202.

Backend server: a backend server may be centrally deployed as a service within a manufacturer's premises to manage migration events from multiple datacenters 210. It may accept all types of files and logs uploaded from CDN servers and DECs 202 (e.g., sent via the CDN servers). It may also perform predictive analysis on the data and find ways to enhance the security of datacenters 210 and the data migration processes generally.

According to one embodiment, a data migration process in the context of FIGS. 2-3 may be carried out in the following steps.
1. Identification of target system: This step identifies the system to which the data is to be migrated, along with the relevant services, virtual disks, datastores, ports, etc.
2. Copy of validation script: the migration tool running at the DEC may send a copy of the migration script to the target system to secure the whole process of migration. The script may specify various details regarding the migration.
3. Initial scan: This step ensures that only required or legitimate user sessions are active at the target system. No out-of-network or suspicious users should be logged into the target system during the migration.
4. Trigger of migration: Once the initial scan is completed, the migration process may begin. Based on data prioritization and identification logic, it may start with non-critical data first, and in parallel it may continue to run validations and keep track of the actions being performed on the target system. In various embodiments, the determination of which data is critical vs. non-critical may be made based on user input, file types, file usage patterns, and/or other heuristics. One embodiment is discussed below in more detail with regard to data prioritization rules.
5. During migration: A read and/or write lock may be applied on the data being currently migrated. To maintain data integrity, only the socket/process involved in migration may retain read and write access in some embodiments. If there are no attempts to break this lock or any other kind of suspicious activities or warnings, then all the data may continue to be migrated.
6. In case of issues: If there are any suspicious activities or unused/high-risk accounts etc. present on the system, the administrator may be notified, and non-critical data may continue to migrate. Upon validation and handling of the error, the full migration process may be completed. If the administrator fails to address the risks, all the non-critical data may be migrated in the background, and critical data may be put on hold, and the system will wait for the administrator to act on the warning.
7. Stop migration and rollback if excessive user authentication takes place (exceeding threshold): If the number of user authentication requests (or other specified events) cross a threshold on the target system, then the migration process may be stopped and the process rolled back.
8. Add all failures to logs: The migration tool captures the details of the accounts for which any unwanted activities were observed. These account may be reported to the administrator to take corrective actions. This data may be passed on the CDN server in form of logs, which may then pass them along to the backend server. The backend server may use machine learning or any other suitable technique to analyze the logs and improve the migration procedures for future migrations.

In general, the DEC may be connected to a local CDN server for support in monitoring and facilitating migrations. A service within the DEC referred to herein as QuickScan may be called before any migration. The QuickScan service may transmit validation scripts to the target system and run tests to ensure that the target system is ready for the migration. Once the QuickScan is complete, the migration process will start.

During configuration of the DEC, the administrator may provide parameters which will be used in prioritization of data during migration. Prioritization rules may be based on certain field string types, patterns, personally identifiable information (PII), etc. The DEC may then monitor the data migration with data prioritization logic in effect. Once a data element (e.g., a file) is selected for migration, the DEC may determine if the element has any sensitive data based on user input parameters and prioritize it accordingly.

The migration process may in some embodiments start with data having lesser sensitivity, and any data with higher sensitivity may be deprioritized in the beginning. During data migration, the DEC may continue observing for signs of problems or threats (e.g., any unknown user authentication, requests to copy/download/upload/alter/delete any of the data being migrated, etc.). In such cases, the DEC may raise a flag to the administrator and continue to transfer only low-sensitivity data. Upon administrator action or acknowledgment of the flag, the rest of the data may be transferred. The administrator may alternatively choose to discontinue with migration, and the whole process may be reversed in such a case.

If there are no signs of threats during migration, the DEC may then begin sending the rest of the data elements which were deprioritized earlier (e.g., the higher-sensitivity data) and complete the process. The DEC may log all the migration events in its own application logs along with all the success and failure details, periodically uploading such logs to the CDN server. These logs may then periodically be uploaded to the backend server for predictive analysis. Upon receiving any updates on threat definitions from CDN, the DEC may update its policies for migrations.

The CDN servers may provide various features. For example, there may be several CDN servers deployed based on business requirements in such a way that all DECs will be able to register with a local CDN server (e.g., a CDN server within a specified geographical radius of the DEC). CDN servers are the first point of contact for the DECs to accept different types of uploads. CDN servers may be connected to the backend server as well, to provide logs and data about DEC clients on a periodic basis. The CDN server may pass updates on threat definitions received from the backend server to the DECs. If a data migration must happen across regions, then the CDN servers may provide validation information via the respective DECs.

The backend server may provide various features as well. It may maintain details of all the CDN servers and DECs. It may collects logs and files uploaded from DECs via the CDN servers. It may collects application logs from CDN servers. It may perform predictive analysis on the logs and files received from DECs and CDN servers. And it may provide close observation on all success and failures of migration for identification of evolving threats.

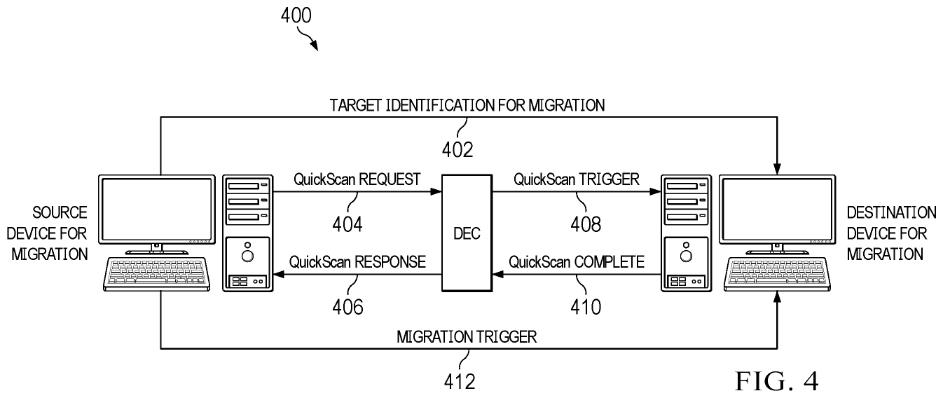

FIG. 4 illustrates an example flowchart of a method 400 for data migration from a source device to a destination device.

First, a source system and a target system are identified for the migration at step 402. At steps 404-410, the DEC receives requests for QuickScan and sends the relevant script for validation at the destination device.

Once the initial scan is complete, at step 412, the DEC sends a signal to trigger initiating the migration. The copied script continues to monitor the target system during migration, and the migration may proceed as discussed above.

One of ordinary skill in the art with the benefit of this disclosure will understand that the preferred initialization points for the method depicted in FIG. 4 and the order of the steps comprising the method may depend on the implementation chosen. In these and other embodiments, the method may be implemented as hardware, firmware, software, applications, functions, libraries, or other instructions. Further, although FIG. 4 discloses a particular number of steps to be taken with respect to the disclosed method, the method may be executed with greater or fewer steps than depicted. The method may be implemented using any of the various components disclosed herein (such as the components of FIG. 1), and/or any other system operable to implement the methods.

This disclosure encompasses all changes, substitutions, variations, alterations, and modifications to the exemplary embodiments herein that a person having ordinary skill in the art would comprehend. Similarly, where appropriate, the appended claims encompass all changes, substitutions, variations, alterations, and modifications to the exemplary embodiments herein that a person having ordinary skill in the art would comprehend. Moreover, reference in the appended claims to an apparatus or system or a component of an apparatus or system being adapted to, arranged to, capable of, configured to, enabled to, operable to, or operative to perform a particular function encompasses that apparatus, system, or component, whether or not it or that particular function is activated, turned on, or unlocked, as long as that apparatus, system, or component is so adapted, arranged, capable, configured, enabled, operable, or operative.

Further, reciting in the appended claims that structure is “configured to” or “operable to” perform one or more tasks is expressly intended not to invoke 35 U.S.C. § 112(f) for that claim element. Accordingly, none of the claims in this application as filed are intended to be interpreted as having means-plus-function elements. Should Applicant wish to invoke § 112(f) during prosecution, Applicant will recite claim elements using the “means for [performing a function]” construct.

All examples and conditional language recited herein are intended for pedagogical objects to aid the reader in understanding the invention and the concepts contributed by the inventor to furthering the art, and are construed as being without limitation to such specifically recited examples and conditions. Although embodiments of the present inventions have been described in detail, it should be understood that various changes, substitutions, and alterations could be made hereto without departing from the spirit and scope of the disclosure.

What is claimed is:

1. An information handling system comprising:
at least one processor; and
a memory;
wherein the information handling system is configured to implement a data edge client that is configured to migrate data from a source system to a target system by:
performing validation prior to the migration;
receiving data prioritization logic;
transferring the data from the source system to the target system in accordance with the prioritization logic;
monitoring for threats during the transferring; and
in response to detecting a threat, performing a remedial action.

2. The information handling system of claim 1, wherein the information handling system is an element of a hyper-converged infrastructure (HCI) system.

3. The information handling system of claim 2, wherein the information handling system is an edge deployment of the HCI system.

4. The information handling system of claim 1, wherein the remedial action comprises stopping the migration and/or rolling back the migration.

5. The information handling system of claim 1, wherein the data prioritization logic specifies a criticality for each element of data, and wherein data elements having lower criticality are prioritized over data elements having higher criticality.

6. The information handling system of claim 1, wherein in response to an occurrence of a warning during the transferring, the information handling system is configured to:
transmit the warning to an administrator; and
not interrupt the transferring.

7. A method comprising:
an information handling system implementing a data edge client that is configured to migrate data from a source system to a target system;
the data edge client performing validation prior to the migration;
the data edge client receiving data prioritization logic;
the data edge client transferring the data from the source system to the target system in accordance with the prioritization logic;
the data edge client monitoring for threats during the transferring; and
in response to detecting a threat, the data edge client performing a remedial action.

8. The method of claim 7, wherein the information handling system is an element of a hyper-converged infrastructure (HCI) system.

9. The method of claim 8, wherein the information handling system is an edge deployment of the HCI system.

10. The method of claim 7, wherein the remedial action comprises stopping the migration and/or rolling back the migration.

11. The method of claim 7, wherein the data prioritization logic specifies a criticality for each element of data, and wherein data elements having lower criticality are prioritized over data elements having higher criticality.

12. The method of claim 7, wherein in response to an occurrence of a warning during the transferring, the information handling system is configured to:
transmit the warning to an administrator; and
not interrupt the transferring.

13. An article of manufacture comprising a non-transitory, computer-readable medium having computer-executable instructions thereon that are executable by a processor of an information handling system for:
implementing a data edge client that is configured to migrate data from a source system to a target system;
the data edge client performing validation prior to the migration;
the data edge client receiving data prioritization logic;
the data edge client transferring the data from the source system to the target system in accordance with the prioritization logic;
the data edge client monitoring for threats during the transferring; and
in response to detecting a threat, the data edge client performing a remedial action.

14. The article of claim 13, wherein the information handling system is an element of a hyper-converged infrastructure (HCI) system.

15. The article of claim 14, wherein the information handling system is an edge deployment of the HCI system.

16. The article of claim 13, wherein the remedial action comprises stopping the migration and/or rolling back the migration.

17. The article of claim 13, wherein the data prioritization logic specifies a criticality for each element of data, and wherein data elements having lower criticality are prioritized over data elements having higher criticality.

18. The article of claim 13, wherein in response to an occurrence of a warning during the transferring, the information handling system is configured to:
transmit the warning to an administrator; and
not interrupt the transferring.
